(19) United States
(12) Patent Application Publication
(10) Pub. No.: US 2015/0014609 A1
(43) Pub. Date: Jan. 15, 2015

(54) SCISSOR-TYPE LIFTING TABLE

(71) Applicant: Christoph Mohr, (US)

(72) Inventor: Christoph Mohr, Bielefeld (DE)

(21) Appl. No.: 14/357,582

(22) PCT Filed: Oct. 23, 2012
(86) PCT No.: PCT/EP2012/004423

§ 371 Date: May 12, 2014

(30) Foreign Application Priority Data
Nov. 16, 2011 (DE) 10 2011 118 672.0

(51) Int. Cl. B66F 7/06

(52) U.S. Cl. CPC B66F 7/065
USPC 254/122

(57) ABSTRACT

A scissor-type lifting table has a carrying device (10) and a base device (11). A scissor mechanism comprising first and second scissor-blade arrangements are arranged between the carrying device (10) and the base device (11). The carrying device (10) can be moved away from the base device (11) by means of a lifting truck (3) which can be moved via at least one traction mechanism (4), by winding up of the traction mechanism (4), and can be raised up in order to open the scissor mechanism and can be lowered in order to close the scissor mechanism by unwinding the traction mechanism (4). At least one lifting cam (8) is provided which is configured to regulate the lifting capacity and along which the lifting truck (3) runs during the raising or lowering of the carrying device (10).

### TECHNICAL FIELD

The invention relates to a scissor-type lifting table in accordance with the generic part of claim 1.

### BACKGROUND INFORMATION

A corresponding scissor-type lifting table is known from DE 100 01 910 84. For lifting the table a lifting truck is drawn by a traction band in the direction of the scissor axis between the crossed scissor blades that can pivot about the scissor axis. The lifting truck runs here via lifting cams fastened in a detachable or adjustable manner on the scissor blades. The lifting cams ensure that the lifting load that is applied by the traction band can be distributed over the lifting procedure in an advantageous manner. This facilitates in particular the starting in the completely lowered state of the scissor-type lifting table.

This construction has absolutely proven itself in the past. However, due to the limited availability of space the possibilities of varying the lifting cams used are limited.

Furthermore, this construction is not sufficiently maintenance-friendly in a certain sense since the traction bands running inside the scissor mechanism in the direction of the scissor axis render the access to some area of the scissor-type lifting table difficult in the case of maintenance and must first be removed, if necessary, in order to be able to carry out maintenance.

### SUMMARY OF THE INVENTION

Therefore, the present invention has the task of improving an initially cited scissor-type lifting table in such a manner that the mentioned disadvantages do not occur.

This task is solved by a scissor-type lifting table with the features of claim 1. Advantageous embodiments are found in the dependent claims.

According to the invention the lifting cam is fastened on the base device so that the lifting truck is guided between the lifting cam and the first scissor blade arrangement. To this end in particular a linear guide is provided that is connected to sections of the first scissor blade arrangement which sections face the base device. Furthermore, the linear guide is provided between the scissor axis and the articulation device connecting the first scissor blade arrangement and the base device.

The articulation device can be, e.g., an articulation bolt connecting the scissor blade arrangement to the base device.

The traction mechanism can preferably be wound on a drum. The drum can be activated by a drive, in particular a drive motor, and is preferably provided on the base device on the side of the articulation device (1b) connecting the first scissor blade arrangement and the base device, which side is located opposite the lifting cam.

This results in numerous advantages. On the one hand more space is available on the base device for the construction of the lifting cam. Furthermore, in this manner the traction mechanism runs approximately parallel to the base device and no longer extends into the interior of the scissor-type lifting table so that hindrances are largely avoided during maintenance. In addition, in this guidance of the traction mechanism a plurality of deflection devices, in particular deflection rollers for the traction mechanism can be installed on the base device which are not located in the lifting area of the scissor-type lifting table and therefore do not hinder the lifting and lowering of the scissor-type lifting table. The providing of a plurality of deflection rollers can realize a block and tackle principle compared to the known solution with which the drive for winding up the traction mechanism can be designed smaller, if necessary, which for its part can save costs.

In addition, it can be provided in particular that the traction mechanism can be guided to the lifting truck by a first deflection device attached to second scissor blade arrangement and by a second deflection device arranged between the articulation device and the drum.

### BRIEF DESCRIPTION OF THE DRAWINGS

These and other features and advantages of the present invention will be better understood by reading the following detailed description, taken together with the drawings wherein:

FIG. 1 shows an exemplary embodiment of the invention.

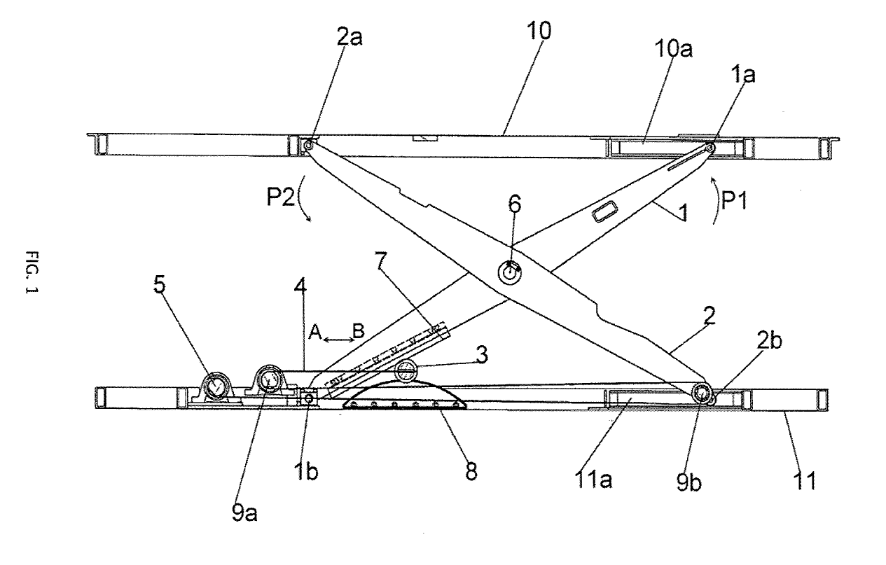

### DETAILED DESCRIPTION OF THE PREFERRED EMBODIMENTS

The scissor-type lifting table is formed by a carrying device 10 for receiving the object to be lifted, a base device 11 to be arranged on the floor or a surface for setting it up and by a scissor mechanism arranged between carrying device 10 and base device 11. The scissor mechanism is formed by crossed scissor blade arrangements, namely, a first scissor blade arrangement 1 and a second scissor blade arrangement 2, that can pivot against one another about a scissor axis 6. Each scissor blade arrangement 1, 2 preferably comprises two or more scissor blades arranged parallel to each other of which only one is represented in the side view shown.

The scissor blades of a scissor blade arrangement 1, 2 are firmly connected, in particular welded to one another e.g., by cross traverses (not shown).

As can be seen in the figure, the scissor mechanism is articulated to the second scissor blade arrangement 2 on the carrying device 10. The articulation takes place here with an articulation bolt 2a. The opposite end 2b of the second scissor blade arrangement is shiftably guided in a guide 11a in the base device 11. In a similar manner, the upper end 1a of the first scissor blade arrangement 1 is guided in a guide 10a in the carrying device 10 whereas the lower end 1b, opposite the end 1a, of the first scissor blade arrangement 1 is articulated to the base device 11. An articulation bolt can also be provided here again that is connected to the scissor blades.

The scissor mechanism is activated by a lift truck 3 that is moved by a drive (not shown) that drives a drum 5. A traction mechanism 4, that preferably comprises at least one band and can be wound on the drum 5 and is connected to the lifting truck 3 is drawn during the winding up on the drum 5 and moves the lifting truck in direction A to the drum 5. The lifting truck 3 moves in the direction of the articulation axis at 1b via the lifting cam 8 and along the linear guide 7 and as a consequence pivots or raises the scissor blade arrangement 1 in direction P1.

As a result, the scissor blade arrangement 2 is also pivoted on account of the coupling on the scissor axis 6 and the carrying device 10 is raised, whereby the ends 1a and 2b are shifted in the particular guides 10a and 11a in direction A.

In order to lower the table and the carrying device 10 the traction mechanism 4 is wound off from the drum. The gravity of the table then brings it about that the lifting truck is moved between the scissor blade arrangement 1 and the lifting cam 8 so far in direction B as the traction mechanism 4 allows. As a result of the winding off of the traction mechanism 4 from the drum the lifting truck 3 is therefore moved substantially in direction B, as a result of which the upper ends 2a and 1a of the two coupled scissor blade arrangements 1, 2 are pivoted toward the base device 11, as is indicated by way of example by arrow P2 for the second scissor blade arrangement 2. The two ends 1a and 2b then move in a corresponding manner in the particular guides 10a, 11a in direction B. As a result the table is lowered.

The traction mechanism 4 is advantageously guided from the drum 5 via a first deflection roller 9b that is attached in the area of the lower end 2b, facing the base device, of the second scissor blade arrangement 2 to the same, and at least via a second deflection roller 9a to the lifting truck 3. The second deflection roller 9a is firmly connected to the base device 11 and preferably arranged between the drum 5 and the articulation axis about which the first scissor blade arrangement 1 is pivotably attached to the base device 11, and the lower end 1b, facing the base device 11, of the first scissor blade arrangement 1.

In this manner a block and tackle principle with a loose and a fixed roller can be realized and thus reduces the requirements on the dimensioning of the unit for the drive of the drum 5.

Modifications and substitutions by one of ordinary skill in the art are considered to be within the scope of the present invention, which is not to be limited except by the following claims.

1. A scissor-type lifting table having a carrying device (10) and a base device (11), whereby a scissor mechanism is arranged between the carrying device (10) and the base device (11) and wherein the scissor mechanism comprises of first and second scissor blade arrangements that cross one another and can pivot about a scissor axis (6) relative to one another and are formed from a plurality of scissor blades (1) and (2) arranged parallel to one another, whereby the carrying device (10) can be moved upward away from the base device (11) by a lifting truck (3), that can be moved by at least one traction mechanism (4), by winding up of the traction mechanism (4), and can be raised up in order to open the scissor mechanism as result, and can be moved toward the base device (11) by unwinding the traction mechanism (4) and can be lowered in order to close the scissor mechanism as a result, and whereby at least one lifting cam (8) is provided on said base (11) and which is configured to regulate the lifting capacity during the lifting operation and along which the lifting truck (3) runs during the raising or lowering of the carrying device (10),
characterized in that the at least one lifting cam (8) is fastened to the base device (11) and the lifting truck (3) is guided between the lifting cam (8) and the first scissor blade arrangement (1) which is pivotably articulated (1b) on the base device (11).

2. The scissor-type lifting table according to claim 1, further including at least one linear guide (7) disposed on a section of the first scissor blade arrangement (1), wherein said section faces the base device (11), and is provided between the scissor axis (6) and the articulation device (1b) connecting the first scissor blade arrangement (1) and the base device (11).

3. The scissor-type lifting table according to claim 1, characterized in that the traction mechanism (4) is configured to be wound on a drum (5) that is provided on the base device (11) on the side, opposite the lifting cam (8), of the articulation device (1b) connecting the first scissor blade arrangement (1) and the base device (11).

4. The scissor-type lifting table according to claim 3, characterized in that the traction mechanism (4) is guided to the lifting truck (3) over a first deflection device (9b) and a second deflection device (9a) arranged between the articulation device (1b) and the drum (5).

5. The scissor-type lifting table according to claim 4, characterized in that the first deflection device (9b) is arranged on an area of the end (2b) of the second scissor blade arrangement (2), which end faces the base device (11), and that the second deflection device (9a) is arranged on the base device (11).

6. The scissor-type lifting table according to claim 4, characterized in that the first and the second deflection devices (9b, 9a) are deflection rollers.
